(19) United States
(12) Patent Application Publication
(10) Pub. No.: US 2015/0302429 A1
(43) Pub. Date: Oct. 22, 2015

(54) REPORT GENERATION SYSTEM AND METHOD

(71) Applicant: Capillary Technologies International Pte Ltd, Singapore (SG)

(72) Inventors: Krishna Kumar Mehra, Kolkata (IN); Prasun Kumar, Bangalore (IN); Pravanjan Choudhury, Bangalore (IN); Abhilash L. Lakkur, Bangalore (IN); Yogesh Jha, Bhagalpur (IN); Sourabh Mundhra, Bangalore (IN)

(21) Appl. No.: 14/684,944

(22) Filed: Apr. 13, 2015

(30) Foreign Application Priority Data
Apr. 22, 2014 (IN) 2053/CHE/2014

(51) Int. Cl. G06Q 30/02; G06Q 10/06

(52) U.S. Cl. CPC G06Q 30/0201; G06Q 10/063

(57) ABSTRACT

A report generation system is provided. The system includes a database configured to store customer data and transactional data for a plurality of customers of a client. The report generation system also includes a query generator accessible by an analyst to define one or more report queries using a plurality of input variables. The query generator is configured to deconstruct the one or more report queries to create a query tree structure. The query tree structure includes a plurality of distinct report queries. The report generation system further includes a report processor configured to process the customer data and the transactional data based on the plurality of distinct report queries and values of input variables to generate one or more reports with output data. The report processor includes a report design module accessible by the analyst to define a plurality of data visualization formats. The report processor is configured to generate the one or more reports with output data displayed in accordance with the defined data visualization formats. The report processor further includes a report communication module configured to provide an interface to deliver the one or more generated reports to a plurality of users. The report communication module is configured to control display of the one or more generated reports to the plurality of users based on an access level of the respective user.

### BACKGROUND

In current customer engagement applications, large enterprises, organizations, stores, retail outlets often employ computer database systems for storing, retrieving and managing large amounts of data generated from, and used during, day-to-day operations. The data stored in such database systems is used by the enterprises, stores, retail outlets, etc. to generate several reports.

Although various report generation systems have been developed to enable users to access the content of data present in database, the availability of large volumes of data to one or more users based on their role in a particular enterprise offers various challenges.

Moreover, it is desirable to access and analyze the data spread across various machines and sources. For example, a user in customer engagement application may require information regarding the sales details for a particular retail store. The user may also require the details of a geographical location where the store is located and other details such as number of unique customers that are registered with the store. In such cases, the data needs to be segregated based on various categories. However, such segregation and analysis of data can be quite cumbersome and time consuming.

### SUMMARY

The following summary is illustrative only and is not intended to be in any way limiting. In addition to the illustrative aspects, embodiments, and features described above, further aspects, embodiments, and features will become apparent by reference to the drawings and the following detailed description.

According to some examples of the present disclosure, a report generation system is provided. The report generation system includes a database configured to store customer data and transactional data for a plurality of customers of a client. The report generation system also includes a query generator accessible by an analyst to define one or more report queries using a plurality of input variables. The query generator is configured to deconstruct the one or more report queries to create a query tree structure. The query tree structure includes a plurality of distinct report queries. The report generation system further includes a report processor configured to process the customer data and the transactional data based on the plurality of distinct report queries and values of input variables to generate one or more reports with output data. The report processor includes a report design module accessible by the analyst to define a plurality of data visualization formats. The report processor is configured to generate the one or more reports with output data displayed in accordance with the defined data visualization formats. The report processor further includes a report communication module configured to provide an interface to deliver the one or more generated reports to a plurality of users. The report communication module is configured to control display of the one or more generated reports to the plurality of users based on an access level of the respective user.

According to additional examples of the present disclosure, a computer-implemented method for generating reports is provided. The method includes defining one or more report queries using a plurality of input variables. The method also includes deconstructing the one or more report queries to form a query tree structure. The query tree structure includes a plurality of distinct report queries. The method further includes processing the customer data and the transactional data based on the plurality of distinct report queries and values of input variables to generate one or more reports with output data. The method further includes displaying the output data in the one or more reports in accordance with a plurality of data visualization formats. In addition, the method also includes displaying selective portions of the one or more generated reports to the plurality of users based on an access level of the respective user.

According to still further examples of the present disclosure, a report generation system is provided. The report generation system includes a database configured to store customer data and transactional data for a plurality of customers of a client. The system also includes a query generator accessible by an analyst to define one or more report queries using a plurality of input variables. The query generator is configured to deconstruct the one or more report queries to create a query tree structure. The query tree structure includes a plurality of distinct report queries. The report generation system further includes a report processor configured to process the customer data and the transactional data based on the plurality of distinct report queries and values of input variables to generate one or more reports with output data. The report processor is configured to apply at least one of a segment variable and a filter variable to the customer data and the transactional data to generate the reports. The report processor further includes a report design module accessible by the analyst to define a plurality of data visualization formats. The report processor is configured to generate the one or more reports with output data displayed in accordance with the defined data visualization formats. In addition, the report processor includes a report communication module configured to provide an interface to deliver the one or more generated reports to a plurality of users. The report communication module is configured to selectively display portions of the one or more generated reports to the plurality of users based on an access level of the respective user.

### BRIEF DESCRIPTION OF THE FIGURES

FIG. 1 is a block diagram illustrating functional components of an example report generation system in accordance with at least some embodiments of the present disclosure.

FIG. 2 is an example configuration of the report processor of the report generation system in accordance with at least some embodiments of the present disclosure.

FIG. 3 illustrates an example process for generating reports based on report queries using the report processor in accordance with at least some embodiments of the present disclosure.

FIG. 4 illustrates an example implementation of generation of a report by combining output data corresponding to multiple report queries in accordance with at least some embodiments of the present disclosure.

FIG. 5 illustrates an example screenshot of a screen for a report communication module of the report generation system in accordance with aspects of the present technique.

FIG. 6 illustrates an example screenshot of a screen that allows an analyst to select reports that can be accessed by a user of an organization in a multi-tenant environment in accordance with aspects of the present technique.

FIG. 7 illustrates an example screenshot of a screen that displays the reports available to multiple users of a particular organization in accordance with aspects of the present technique.

FIG. 8 illustrates an example screenshot of a screen that displays the reports assigned to a user in accordance with aspects of the present technique.

FIG. 9 illustrates an example screenshot of a report execution screen for a user of the report generation system in accordance with aspects of the present technique.

FIG. 10 illustrates an example output data from the generated reports using the report generation system in accordance with aspects of the present technique.

FIG. 11 illustrates another example output data from the generated reports using the report generation system in accordance with aspects of the present technique.

FIG. 12 is a block diagram illustrating an example computing device that is arranged for report generation with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Example embodiments of the present disclosure are generally directed to techniques for generating reports for handling automatic and real time broadcasting of data derived from on-line analytical processing (OLAP) systems. Some example embodiments include techniques to process customer data and the transactional data of a plurality of customers of a client based on report queries to generate one or more reports with the output data. The report queries may be generated by a user of the system and the generated reports may display output data displayed in accordance with pre-defined data visualization formats. Further, the generated reports and selective content of the reports may be accessible by multiple users based on certain parameters such as their profile and/or role in a particular organization.

In some embodiments, the report generation system is adapted to operate in a multitenant source database setup. In general, multi-tenancy refers to a principle in software architecture where a single instance of software runs on a server, serving multiple client-organizations generally referred as tenants. In multitenant database architecture, a schema is designed to partition its data and configuration by an organization identifier, and each client-organization works with the data indexed with its own organization identifier.

Some embodiments of the present disclosure are implemented within an enterprise's OLAP project schema development, report generation, report publishing and report visualization workflow.

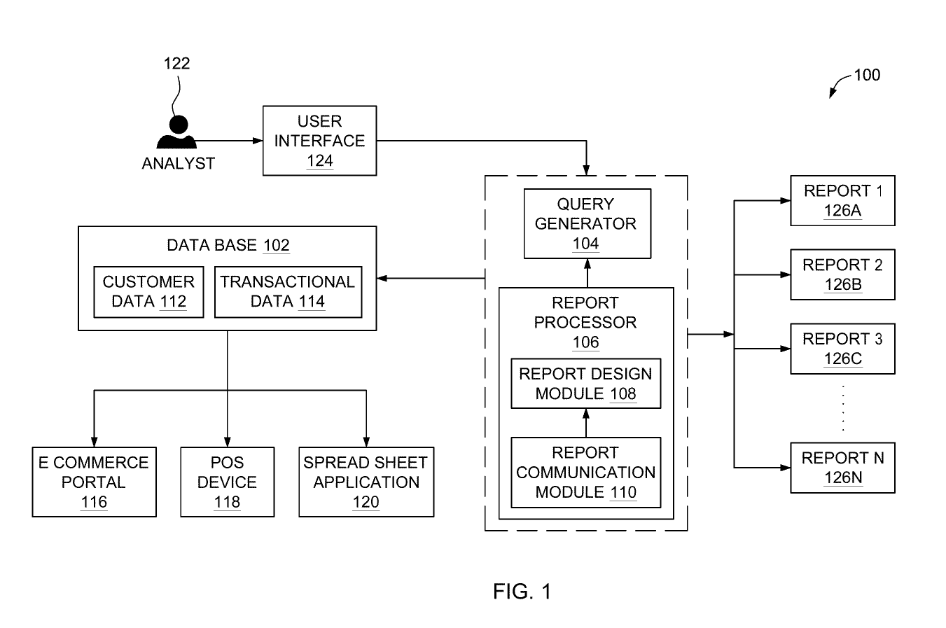

FIG. 1 is a block diagram illustrating functional components of an example report generation system 100 in accordance with at least some embodiments of the present disclosure. The report generation system 100 includes a database 102, a query generator 104 and a report processor 106. The report processor 106 further includes a report design module 108 and a report communication module 110. Each component of the report generation system 100 is described in further detail below.

The database 102 is configured to store customer data 112 and transactional data 114 for a plurality of customers of a client. In one example, the database 102 includes an online analytical processing (OLAP) system. The OLAP system 102 is configured to extract data from a plurality of data sources. For example, the plurality of data sources may include an electronic commerce (e-commerce) portal 116, a point of sale (POS) device 118, and a spread sheet 120. In some examples, the report generation system 100 extracts the data from the online transaction processing (OLTP) into its OLAP and converts it into shards.

In an example embodiment, the database 102 includes data obtained from the e-commerce portal 116 of a client. Such data includes information related to customer data 112 and transactional data 114 of customers of the client.

In an example embodiment, the database 102 includes data obtained with one or more point of sale (POS) devices 118 located in a store of the client. The one or more POS devices 118 are configured to process transactions of multiple customers in the store. For example, the POS devices 118 may comprise a cash register with a scanning station for scanning of barcodes on the goods, or other means for registering the goods, e.g. a keyboard, keypad or other input means for manually inputting prices and/or product IDs, means for registering product information stored on a microchip, etc. Such transactional data from the POS devices 118 may be communicated to the database 102. In another example, the database 102 includes data extracted from a spread sheet application 120. Such data may be stored in the spread sheet application using a pre-defined format such as an excel import format.

As described above, the database 102 includes the customer data 112 and the transactional data 114. Examples of the customer data 112 include, but are not limited to, data related to age bands of the customers, location of the customers, names of the customers, client loyalty points of the customers, loyalty tiers of the customers, lifetime points of the customers, lifetime purchase value of the customers, number of days since last visit for the customers, number of total visits of the customers, average number of items bought per purchase by the customers, or combinations thereof.

Examples of the transactional data 114 include, but are not limited to, data regarding purchases made by the customers, registration of the customers, purchase location of the customers, payment modes used by the customers, redemption of one or more offers provided to the customers by the client, or combinations thereof.

The query generator 104 is accessible by an analyst 122 via a user interface 124 to define one or more report queries using a plurality of input variables. For example, the input variables can include start and end dates for a period of analysis of data, a set of stores for which the data needs to be generated, a type of product for which the data needs to be generated and so forth. The query generator 104 is configured to deconstruct the one or more report queries to create a query tree structure. The query tree structure comprises a plurality of distinct report queries. In some examples, the query generator 104 may comprise a structured query language (SQL) based query parser. Other techniques of defining the one or more report queries may be contemplated. In certain examples, multiple report queries may be processed and output data for each of these queries can be combined to generate the report.

The query generator 104 allows the analyst 110 to define one or more report queries to manipulate the customer data 112 and the transactional data 114. Moreover, the report processor 106 is configured to process the customer data 112 and the transactional data 114 based on the plurality of distinct report queries and values of input variables to generate one or more reports such as represented by reference numerals 126-A through 126-N. The report processor 104 is configured to receive values of the input variables through the user interface 124. The report processor 104 is configured to generate the one or more reports 126-A through 126-N with output data displayed in accordance with a plurality of data visualization formats.

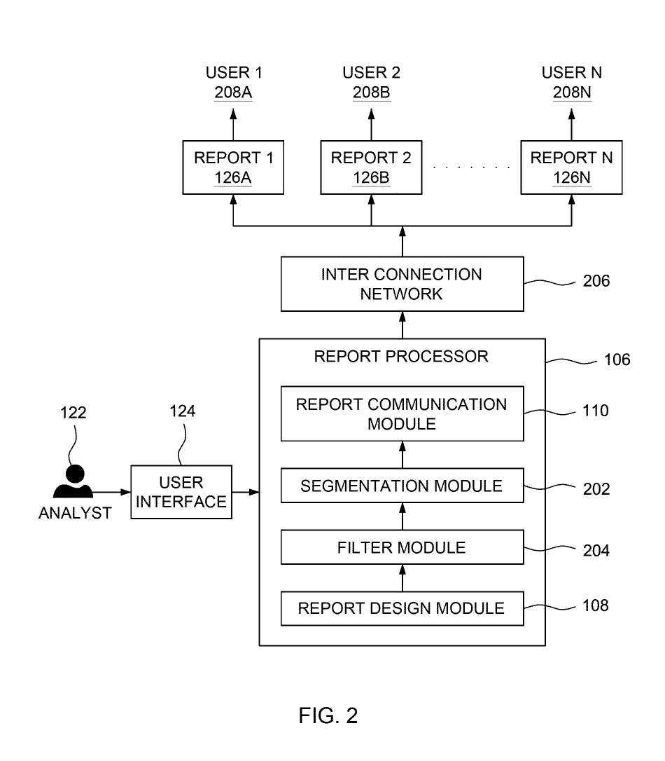

Furthermore, the analyst 122 can define data visualization formats using the report design module 108. Example data visualization formats include, but are not limited to, pie charts, line chart, bar graphs, tabular formats, dashboards, or combinations thereof. Further, the generated reports 126-A through 126-N are delivered to a plurality of users of the system 100 using the report communication module 110. The functional and operational details of the report processor 106 are described in further detail below with reference to FIG. 2.

FIG. 2 illustrates an example configuration of the report processor 106 of the report generation system 100 of FIG. 1. In this example configuration, the report processor 106 includes the report design module 108, and the report communication module 110. In addition, the report processor 106 includes a segmentation module 202 and a filter module 204.

In the illustrated embodiment, the report design module 106 is accessible by the analyst 122 via the user interface 124 to define a plurality of data visualization formats. Example data visualization formats include, but are not limited to, pie charts, bar graphs, tabular formats, dashboards, or combinations thereof. The report processor 106 is configured to generate the one or more reports 126-A through 126-N with output data displayed in accordance with the defined data visualization formats. For example, the visualization formats of output data in the one or more generated reports 126-A through 126-N may be represented in a dashboard view, a tabular format, a graphical format, a pie chart format, or combinations thereof.

In certain examples, one or more data visualization formats are combined into views and these views may further be combined to form pages of the reports. The multiple visualization formats described above allows for configurable mini dashboards that can be visualized by the users (such as represented by reference numerals 208A through 208N) of the system.

The report processor 106 is further configured to apply at least one of a segment variable and a filter data to the customer data 112 and the transactional data 114 and the output data can be utilized by the one or more users 208-A through 208-N to drill down and analyze the data categories of interest.

In the illustrated embodiment, the segmentation module 202 is configured to fragment and the customer data 112 and the transactional data 114 into plurality of data segments based on the segment variables. Examples of the segment variables include, but are not limited to, an age band of the customers, a geographical location of a retail store of the client, a region of a retail store of the client, a product type, a product category, a product target segment, a product brand, customers targeted in a campaign by the client, customers that have responded to a campaign of the client, number of days since last visit for the customers of the client, customers categorized based on a number of purchases made for a particular brand of the client, a payment mode used by the customers, or combinations thereof.

For example, a user may generate data segments to view output data such as sales of a particular retail store for a particular age band of customers. Similarly, output data corresponding to sales for a product type such as apparel may be generated by applying the appropriate segment variables to the customer data 112 and the transactional data 114. Thus, the segmentation module 202 facilitates the user to generate reports with output data corresponding to particular segment variables defined and selected by the user.

Moreover, the filter module 204 is configured to apply filter variables to generate filtered data. Examples of the filter variables include, but are not limited to, a time period of sales of a product of the client, a loyalty tier of a customer, client loyalty points of a customer, customers that have responded to a campaign of the client, historical data of lifetime purchase of a customer, number of visits of a customer to a retail store, or combinations thereof.

In one example, a user can generate filtered data with marketing data corresponding to a particular period of sales (say for first three months of an year). Similarly, a user can generate filtered data with response data indicating a number of customers that have responded to a campaign of the client. Thus, the filter module 204 facilitates the user to generate reports with output data corresponding to particular segment variables defined and selected by the user.

The report communication module 110 is configured to provide an interface to deliver the one or more generated reports 126-A through 126-N to the plurality of users 208-A through 208-N. In the illustrated embodiment, the report communication module 110 is configured to control display of the one or more generated reports 126-A through 126-N to the plurality of users 208-A through 208-N based upon an access level of the respective user. The access level of the users 208-A through 208-N may be determined based upon a client/organization, a role of a user in an organization, an industry that the organization caters to like apparel or fast food chain, a size of the organization (e.g., number of active customers, number of operating stores), or combinations thereof. In operation, the report communication module 110 is configured to selectively display portions of the one or more generated reports 126-A through 126-N to the plurality of users 208-A through 208-N based on the access level of the respective user.

In one embodiment, the access level of one or more users 208-A through 208-N is defined based upon a role of the respective user. For example, the role of the user may be defined as a marketing manager, a store head of a retail store, a chief executing officer (CEO), a software programmer and so forth. The access level for each of these roles may be pre-defined and the respective user may have access only to selective reports and/or certain portions of the reports. For example, a marketing manager may have access to sales report for a particular region. Similarly, the CEO may be able to access the reports of an entire organization.

In addition, the data visualization formats for each of these reports can be customized for each role. In one example, the CEO can view the sales data in form of dashboards indicative of overall sales of the particular organization. In another example, the marketing manager can view the details of sales for a particular retail store with charts showing comparison of sales of different products from that store. A variety of data visualization formats may be envisaged for such reports that are accessible by different users of the system. As will be appreciated by one skilled in the art, the report communication module 110 is configured to control the access to the one or more generated reports for a plurality of clients of the system.

In another embodiment, the report communication module 110 is configured to control access to the one or more generated reports 126-A through 126-N based upon a type of products associated with the clients of the system. The report communication module 110 is configured to associate tags for each type of products and to control the access and content of the reports to be displayed based upon the tags. For example, a report with market data for apparel can be accessible to a set of users of an organization. In another example, a report with sales data for books can be accessible by another set of users of the organization. As can be seen, reports for different types of products offered by a client/organization may be accessible by a different set of users of the client/organization.

The report communication module 110 is configured to deliver the one or more reports 126-A through 126-N to the plurality of users 208-A through 208-N via one or more interconnection networks 206. In one example, the interconnection network 206 is an email service. In another example, the interconnection network 206 is a short message service (SMS).

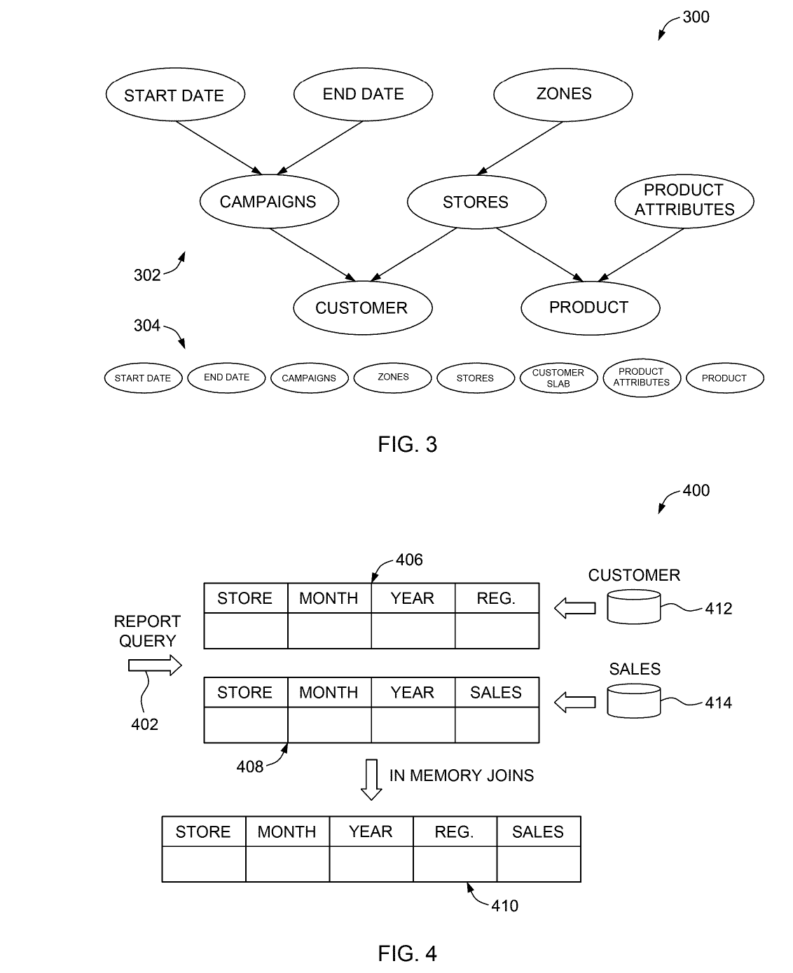

FIG. 3 illustrates an example process 300 for generating reports based on report queries using the report processor 106 of FIG. 2. In the illustrated embodiment, input variables are represented by reference numeral 302. In this example, the input variables 302 include “start date”, “end date”, “zones”, “campaigns”, “stores”, “product attributes”, “product” and “customer”. It should be noted that a plurality of other input variables 302 may be envisaged.

In one embodiment, the report execution flow implemented by the report processor 106 includes two stages. The first stage of the report execution flow includes processing of the input variables. The second stage of the report execution flow includes detemplatization and execution of distinct report queries. In some examples, the report stage execution utilizes a workflow engine that resolves the input variables dependencies. The workflow engine performs a topological sorting of a variable dependency graph of the input variables and a sequence of the input variables are grouped into one or more stages.

During operation, each stage is executed in sequence after the system receives values of the input variables from the user of the system. For example, the execution of data in sequence is represented by reference numeral 304. The data for input variables (e.g. date, or a value) for the particular stage may be received from the user via the user interface 124. In another embodiment, the data may be defined from a query execution at the backend of the system. For example, a multi select box in a stage to select zones may comprise data retrieved from a query execution, before providing the stage at user interface.

FIG. 4 illustrates an example implementation 400 of generation of a report by combining output data corresponding to multiple report queries. In the illustrated embodiment, a report query 402 is processed by the report processor 106 to generate the report. In this example, the report query 402 includes the store name (STORE), a number (REG) of unique customers that are registered at the given store, and the sales amount (SALES) of the particular store.

In the illustrated embodiment, the number of unique customers that are registered at the given store is a key performance indicator (KPI) that can be retrieved from customer data 412 while the sale amount (SALES) can be retrieved from the sales transaction data 414. In this example, two separate queries are processed by the report processor 106 and the outputs represented by reference numerals 406 and 408 respectively corresponding to these queries are combined to generate the required output 410 for the particular store. In operation, as the outputs 406 and 408 are retrieved in memory from the customer data 412 and the sales transaction data 414, the rows are concatenated from both tables 406 and 408 based on primary key set to create rows of the resultant output 410. The resultant table then resembles the actual cross cube join. It should be noted that since the output of each query is already rolled up, the amount of data to be loaded in the memory results in a reduced amount of work.

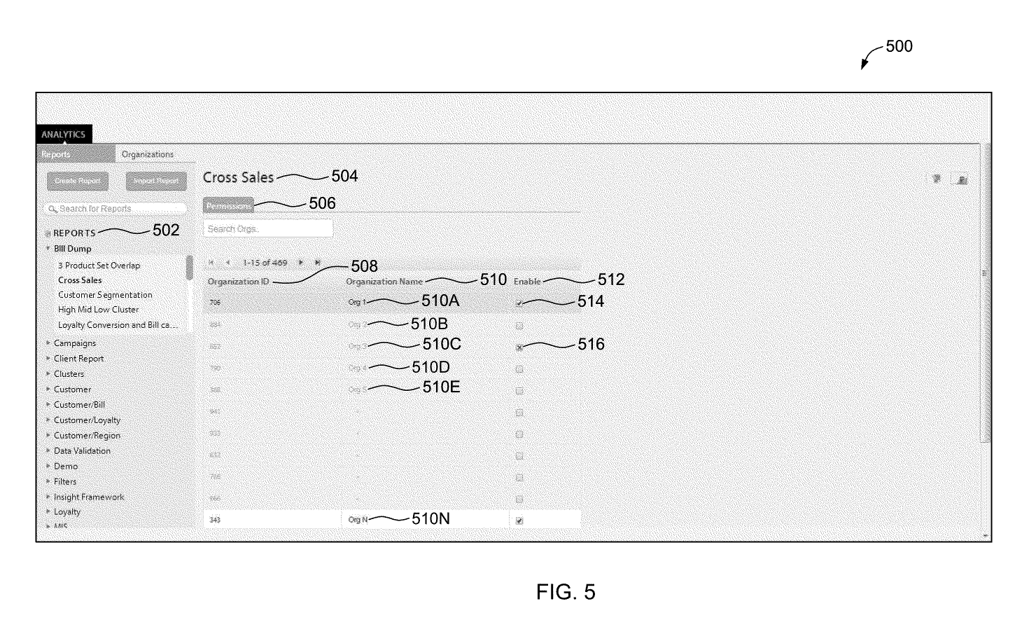

FIGS. 5-9 illustrate example screenshots for the report generation system 100 of FIG. 1. FIG. 5 is an example screen shot 500 of for report communication module that allows an analyst to choose the reports to be made accessible to an organization in a multi-tenant environment. As can be seen, the home screen 500 includes the “reports” tab 502 that shows a number of reports available for viewing by one or more users of the report generation system 100. Each of the reports such as the “Cross Sales” report 504 includes a permissions field 506 that is configured to display the access permissions for the respective report. Moreover, the home screen 500 includes one or more organisation identifiers 508, organization names 510-A through 510-N, and a corresponding access setting (generally represented by the reference numeral 512) for the organization.

The access setting 512 for a particular report such as the report 504 may be enabled or disabled to be accessed and/or viewed by each organization. For example, an active checkbox 514 enables the organization 510-A to access and view certain reports for the organization 510-A. Similarly, the deactivated checkbox 516 disables the organization 510-E to access and view of certain reports. It should be noted that such access permissions may be assigned for each of the generated reports and such permissions facilitate access control for a plurality of organizations and users of the organizations. As described before, such access control may be based on a type of the organization, a role of a user within the organization, a type of product associated with the organization, and combinations thereof.

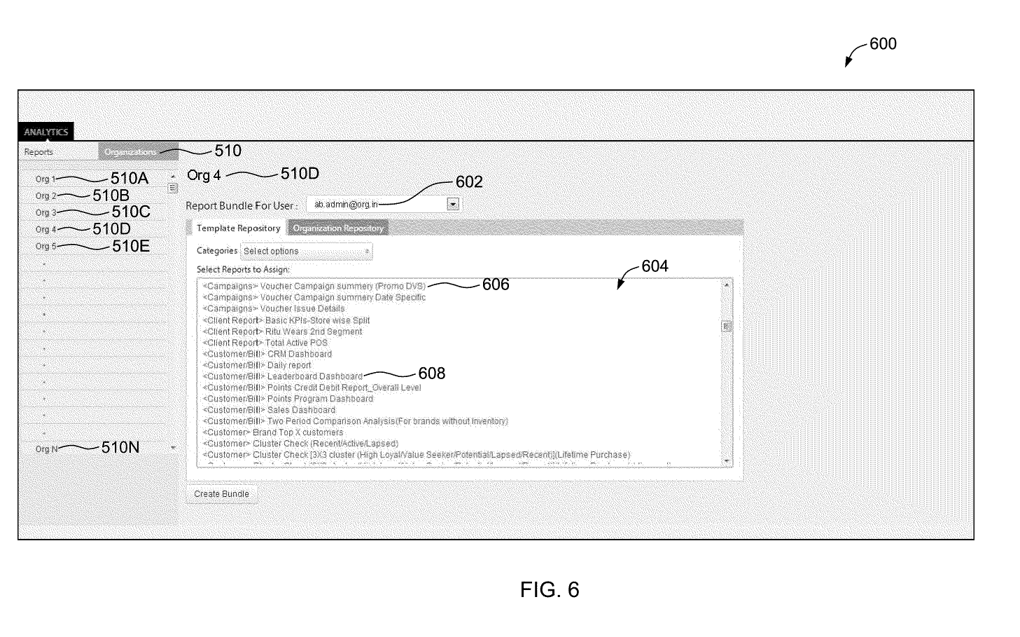

FIG. 6 shows an example screenshot 600 of a screen that allows an analyst to choose the reports and report categories that can be accessed by the user of an organization in a multi-tenant environment. The screen 600 includes a user identifier 602 to which a number of reports can be assigned. In one example, the user identifier includes an email address of the user. However, other identifiers may be used.

Here, an organization can be selected from a list 510 of the organizations registered with the system 100 and the reports available to the selected organization can be viewed. For example, as the user selects the organization 510-D, details of the reports that are available for the organization 510-D are displayed. In this example, the reports 604 for the organization 510-D include a voucher campaign summary 606 and leaderboard dashboard 608. These reports 606 and 608 are assigned to the respective user and can be subsequently accessed by the user of the organization 510-D. It should be noted that a number of reports may be assigned to a plurality of users based on a desired level of access control for each of the users.

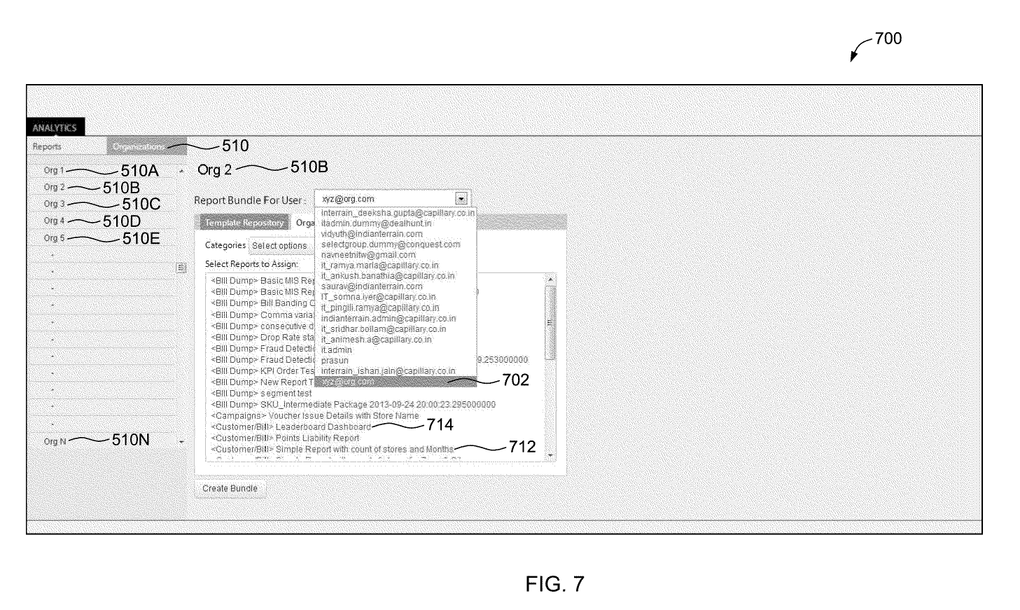

FIG. 7 shows an example screenshot 700 of a screen that displays the reports available to multiple users of a particular organization and allows the analyst to choose which of those exclusive reports to be made accessible to which users of that organization. The screen includes a number of organizations such as represented by reference numerals 510-A through 510-N. An organization can be selected and a list of reports available to the users of the selected organization can be displayed.

In this example, the reports that are available to a user with the user identifier 702 of the organization 510-B are displayed on the screen 700. For example, the user can access a simple report with count of stores and months (712) and a report illustrating the leaderboard dashboard 714. Similarly, each user of the organization identified with a unique user identifier can access one or more generated reports based upon the assigned access control settings of the respective user.

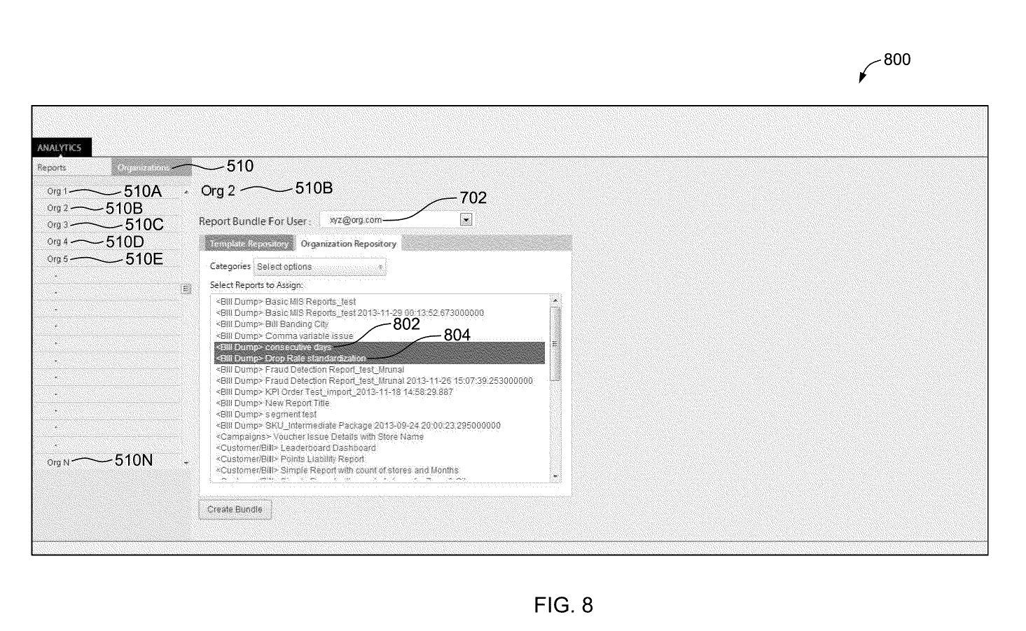

FIG. 8 shows an example screen shot 800 of a screen that displays the reports assigned to a user. As illustrated, the screen 800 displays a set of reports published for a user of the organization. In this example, the screen 800 displays reports such as represented by reference numerals 802 and 804 for a user 702 of an organization 510-B. As described before, a set of reports may be selected from the available reports for an organization and the selected reports may be assigned to a particular user of the organization.

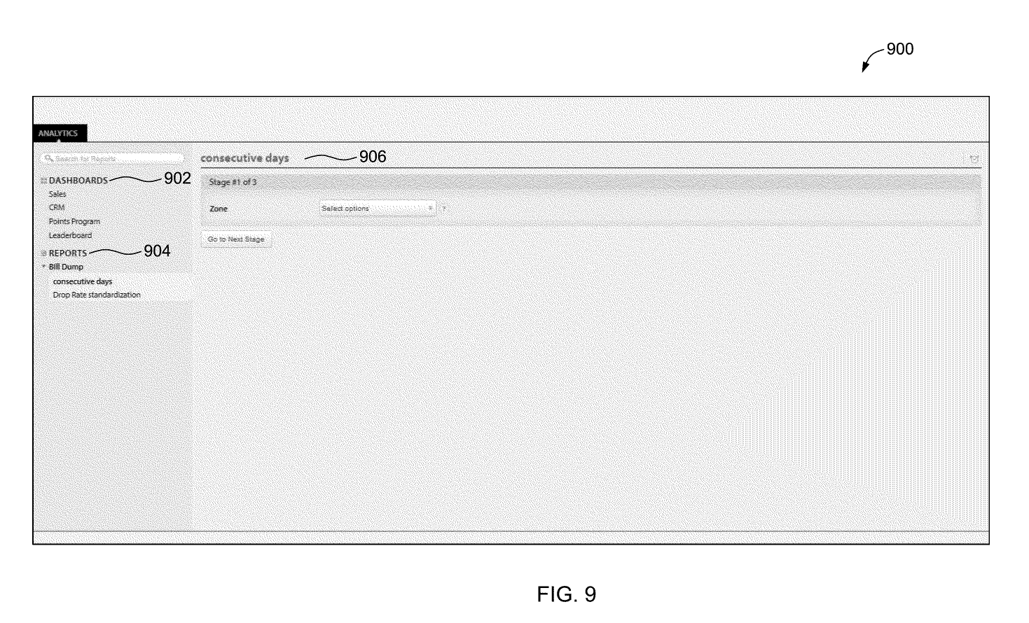

FIG. 9 shows an example screen shot of a report execution for a user of the report generation system. In this example, as the user accesses the system, a list of reports (e.g., dashboards 902 and reports 904) available to the user is displayed. The user can then select a report such as represented 906 to view the contents of the report.

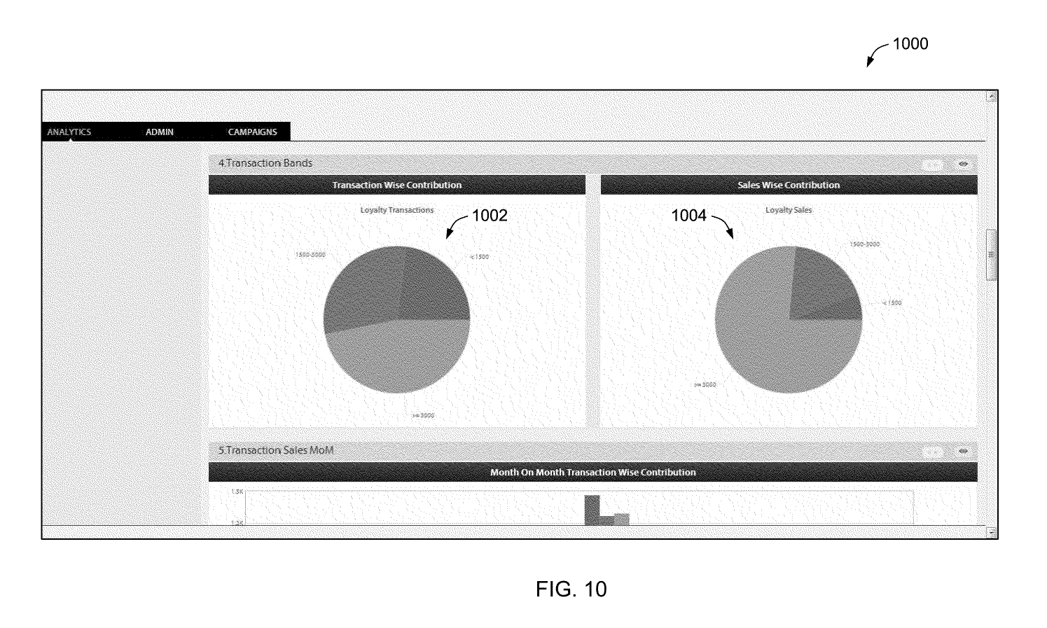

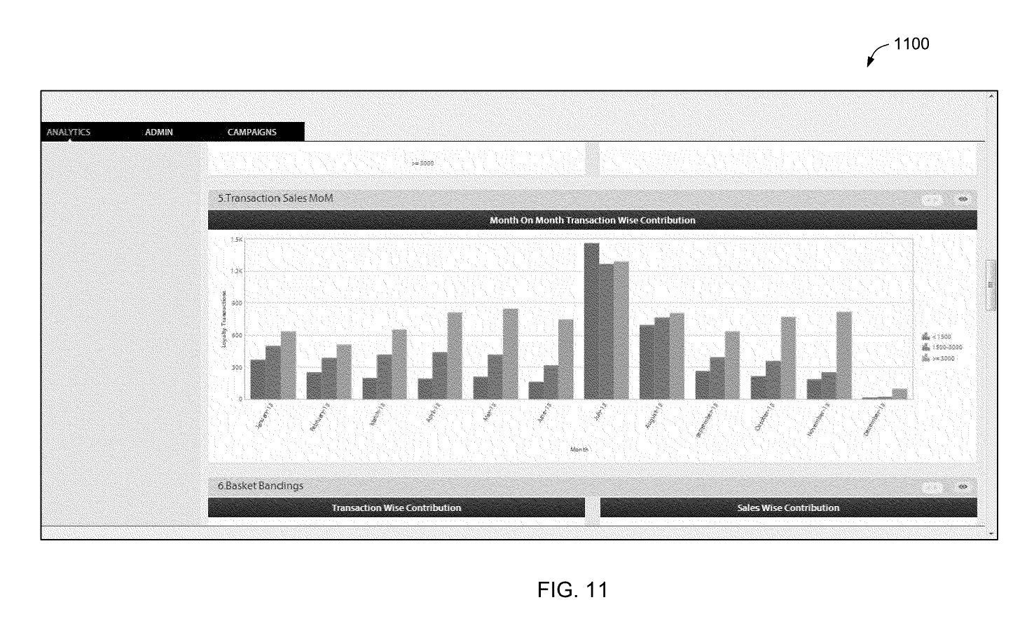

FIGS. 10 and 11 show example output data from the generated reports using the report generation system of FIG. 1. In one example, the output data 1000 includes pie charts of transaction wise contribution and sales wise contribution of a store represented by reference numerals 1002 and 1004. In another example, the output data 1100 includes bar chart of monthly transaction sales of a store. As will be appreciated by one skilled in the art, a variety of other data visualization formats may be employed to view the output data in the generated reports.

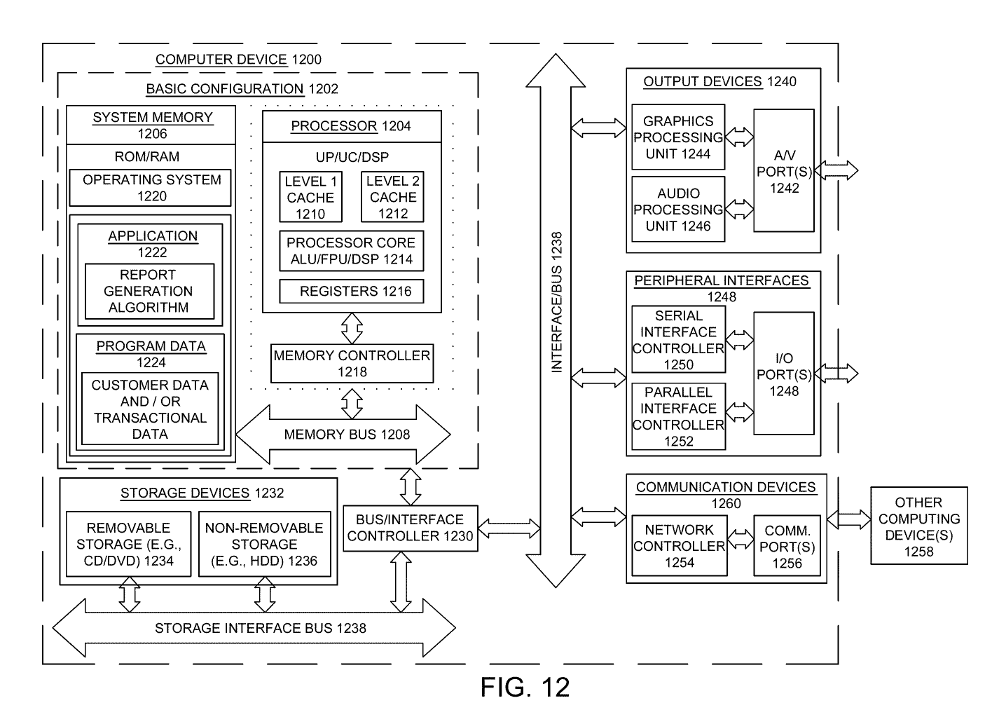

FIG. 12 is a block diagram illustrating an example computing device 1200 that is arranged for report generation with at least some embodiments of the present disclosure. In a very basic configuration 1202, the computing device 1200 typically includes one or more processors 1204 and a system memory 1206. A memory bus 1208 may be used for communicating between processor 1204 and system memory 1206. The processor 1204 includes a multi-core processor.

Depending on the desired configuration, processor 1204 may be of any type including but not limited to a microprocessor (μP), a microcontroller (μC), a digital signal processor (DSP), or any combination thereof. Processor 1204 may include one more levels of caching, such as a level one cache 1210 and a level two cache 1212, two or more processor cores 1214, and registers 1216. An example processor core 1214 may include an arithmetic logic unit (ALU), a floating point unit (FPU), a digital signal processor core (DSP Core), or any combination thereof. An example memory controller 1218 may also be used with processor 1204, or in some implementations memory controller 1218 may be an internal part of processor 1204.

Depending on the desired configuration, system memory 1206 may be of any type including but not limited to volatile memory (such as RAM), non-volatile memory (such as ROM, flash memory, etc.) or any combination thereof. System memory 1206 may include an operating system 1220, one or more applications 1222, and program data 1224. In some embodiments, application 1222 may be arranged to operate with program data 1224 on operating system 1220. This described basic configuration 1202 is illustrated in FIG. 12 by those components within the inner dashed line. Application 1222 may include algorithm for report generation. Program data 1224 may include the customer data and/or transactional data of a plurality of customers.

Computing device 1200 may have additional features or functionality, and additional interfaces to facilitate communications between basic configuration 1202 and any required devices and interfaces. For example, a bus/interface controller 1230 may be used to facilitate communications between basic configuration 1202 and one or more data storage devices 1232 via a storage interface bus 1234. Data storage devices 1232 may be removable storage devices 1236, non-removable storage devices 1238, or a combination thereof.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1206, removable storage devices 1236 and non-removable storage devices 1238 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1200. Any such computer storage media may be part of computing device 1200.

Computing device 1200 may also include an interface bus 1240 for facilitating communication from various interface devices (e.g., output devices 1242, peripheral interfaces 1244, and communication devices 1246) to basic configuration 1202 via bus/interface controller 1230. Example output devices 1242 include a graphics processing unit 1248 and an audio processing unit 1250, which may be configured to communicate to various external devices such as a display or speakers via one or more A/V ports 1252.

Example peripheral interfaces 1244 include a serial interface controller 1254 or a parallel interface controller 1256, which may be configured to communicate with external devices such as input devices (e.g., keyboard, mouse, pen, voice input device, touch input device, etc.) or other peripheral devices (e.g., printer, scanner, etc.) via one or more I/O ports 1258. An example communication device 1246 includes a network controller 1260, which may be arranged to facilitate communications with one or more other computing devices 1262 over a network communication link via one or more communication ports 1264.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1200 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1200 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” teams (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A report generation system comprising:
a database configured to store customer data and transactional data for a plurality of customers of a client;
a query generator accessible by an analyst to define one or more report queries using a plurality of input variables, wherein the query generator is configured to deconstruct the one or more report queries to create a query tree structure, wherein the query tree structure comprises a plurality of distinct report queries; and
a report processor configured to process the customer data and the transactional data based on the plurality of distinct report queries and values of input variables to generate one or more reports with output data, wherein the report processor further comprises:
a report design module accessible by the analyst to define a plurality of data visualization formats, wherein report processor is configured to generate the one or more reports with output data displayed in accordance with the defined data visualization formats;
a report communication module configured to provide an interface to deliver the one or more generated reports to a plurality of users, wherein the report communication module is configured to control display of the one or more generated reports to the plurality of users based on an access level of the respective user.

2. The system of claim 1, wherein the customer data comprises data related to age bands of the customers, location of the customers, names of the customers, client loyalty points of the customers, loyalty tiers of the customers, lifetime points of the customers, lifetime purchase value of the customers, number of days since last visit for the customers, number of total visits of the customers, average number of items bought per purchase by the customers, or combinations thereof.

3. The system of claim 1, wherein the transactional data comprises data regarding purchases made by the customers, registration of the customers, purchase location of the customers, payment modes used by the customers, redemption of one or more offers provided to the customers by the client, or combinations thereof.

4. The system of claim 1, wherein the report processor is configured to apply at least one of a segment variable and a filter variable to the customer data and the transactional data to generate the reports.

5. The system of claim 4, wherein the report processor further comprises:
a segmentation module configured to fragment the customer data and the transactional data into plurality of data segments based on the segment variables; and
a filter module configured to apply filter variables to generate filtered data.

6. The system of claim 5, wherein the segment variables comprise an age band of the customers, a geographical location of a retail store of the client, a region of a retail store of the client, a product type, a product category, a product target segment, a product brand, customers targeted in a campaign by the client, customers that have responded to a campaign of the client, number of days since last visit for the customers of the client, customers categorized based on a number of purchases made for a particular brand of the client, a payment mode used by the customers, or combinations thereof.

7. The system of claim 5, wherein the filter variables comprise a time period of sales of a product of the client, a loyalty tier of a customer, client loyalty points of a customer, customers that have responded to a campaign of the client, historical data of lifetime purchase of a customer, number of visits of a customer to a retail store, or combinations thereof.

8. The system of claim 1, wherein the access level of the user is defined based upon a client of the system, a role of the respective user, or combinations thereof.

9. The system of claim 1, wherein the report communication module is configured to control access of the one or more generated reports for a plurality of clients of the system.

10. The system of claim 9, wherein the report communication module is configured to control access to the one or more generated reports based upon type of products associated with the clients of the system.

11. The system of claim 10, wherein the report communication module is configured to associate tags for each type of products and to control the access and content of the reports to be displayed based on the associated tags.

12. The system of claim 1, wherein the report communication module is configured to transmit the generated reports to the plurality of users via one or more interconnection networks.

13. The system of claim 1, wherein the plurality of visualization formats comprise a dashboard, a tabular format, a graphical format, a pie chart format, or combinations thereof.

14. The system of claim 1, wherein the report processor is configured to generate the one or more reports with one or more reporting pages, wherein each reporting page comprises output data represented in accordance with predefined data visualization formats to facilitate viewing of selective output data by the users.

15. The system of claim 1, wherein the report processor further comprises a user interface to receive values of the plurality of input variables and to generate the reports corresponding to the received values of the input variables.

16. The system of claim 1, wherein the report processor is configured to combine results corresponding to the plurality of distinct report queries.

17. The system of claim 1, wherein the database comprises an online analytical processing (OLAP) system, wherein the OLAP system is configured to extract data from a plurality of data sources.

18. The system of claim 17, wherein the plurality of data sources comprises data associated with e-commerce portal, a point of sale (POS) application, a spreadsheet application, or combinations thereof.

19. A computer implemented method for generating reports, the method comprising:
storing customer data and transactional data for a plurality of customers of a client;
defining one or more report queries using a plurality of input variables,
deconstructing the one or more report queries to form a query tree structure, wherein the query tree structure comprises a plurality of distinct report queries;
processing the customer data and the transactional data based on the plurality of distinct report queries and values of input variables to generate one or more reports with output data;
displaying the output data in the one or more reports in accordance with a plurality of data visualization formats;
displaying selective portions of the one or more generated reports to the plurality of users based on an access level of the respective user.

20. The method of claim 19, wherein processing the customer data and the transactional data further comprises applying at least one of a segment variable and a filter variable to the customer data and the transactional data.

21. The method of claim 20, further comprising
fragmenting the customer data and the transactional data into plurality of data segments based on the segment variables; and
applying filter variables for generating filtered data.

22. The method of claim 19, further comprising transmitting the generated reports to the plurality of users via one or more interconnection networks.

23. The method of claim 19, further comprising receiving values of the plurality of input variables and generating the reports corresponding to the received values of the input variables.

24. A report generation system comprising:
a database configured to store customer data and transactional data for a plurality of customers of a client;
a query generator accessible by an analyst to define one or more report queries using a plurality of input variables, wherein the query generator is configured to deconstruct the one or more report queries to create a query tree structure; wherein the query tree structure comprises a plurality of distinct report queries;
a report processor configured to process the customer data and the transactional data based on the plurality of distinct report queries and values of input variables to generate one or more reports with output data, wherein the report processor is configured to apply at least one of a segment variable and a filter variable to the customer data and the transactional data to generate the reports and wherein the report processor further comprises:
a report design module accessible by the analyst to define a plurality of data visualization formats, wherein report processor is configured to generate the one or more reports with output data displayed in accordance with the defined data visualization formats;
a report communication module configured to provide an interface to deliver the one or more generated reports to a plurality of users, wherein the report communication module is configured to selectively display portions of the one or more generated reports to the plurality of users based on an access level of the respective user.

25. The system of claim 24, wherein the customer data comprises data related to age bands of the customers, location of the customers, names of the customers, client loyalty points of the customers, loyalty tiers of the customers, lifetime points of the customers, lifetime purchase value of the customers, number of days since last visit for the customers, number of total visits of the customers, average number of items bought per purchase by the customers, or combinations thereof.

26. The system of claim 24, wherein the transactional data comprises data regarding purchases made by the customers, registration of the customers, purchase location of the customers, payment modes used by the customers, redemption of one or more offers provided to the customers by the client, or combinations thereof.

27. The system of claim 24, wherein the segment variables comprise an age band of the customers, a geographical location of a retail store of the client, a region of a retail store of the client, a product type, a product category, a product target segment, a product brand, customers targeted in a campaign by the client, customers that have responded to a campaign of the client, number of days since last visit for the customers of the client, customers categorized based on a number of purchases made for a particular brand of the client, a payment mode used by the customers, or combinations thereof.

28. The system of claim 24, wherein the filter variables comprise a time period of sales of a product of the client, a loyalty tier of a customer, client loyalty points of a customer, customers that have responded to a campaign of the client, historical data of lifetime purchase of a customer, number of visits of a customer to a retail store, or combinations thereof.
